(19) United States
(12) Patent Application Publication
(10) Pub. No.: US 2011/0173665 A1
(43) Pub. Date: Jul. 14, 2011

(54) SYSTEM AND METHOD OF PERSONALIZED BROADCASTING SERVICE BASED ON SUBSCRIBER TERMINAL

(75) Inventors: Jae Chan Shim, Daejeon (KR); Ho Young Song, Daejeon (KR); Byung Tak Lee, Suwon (KR); Kee Seong Cho, Daejeon (KR)

(73) Assignee: Electronics and Telecommunications Research Institute, Daejeon (KR)

(21) Appl. No.: 13/120,591

(22) PCT Filed: May 22, 2009
(86) PCT No.: PCT/KR09/02718

§ 371 Date: Mar. 23, 2011

(30) Foreign Application Priority Data
Sep. 23, 2008 (KR) 10-2008-0093332

(51) Int. Cl. H04N 5/445

(52) U.S. Cl. 725/46

(57) ABSTRACT

A subscriber terminal-based personalized broadcast service system and method are provided. The subscriber terminal-based personalized broadcast service method includes receiving broadcast program schedule information from a broadcast head-end and receiving content schedule information from at least one content server; creating a personalized channel schedule in which a plurality of broadcast programs and a plurality of contents are arranged according to time with reference to the broadcast program schedule information and the content schedule information; and receiving a broadcast program or a content requested with reference to the personalized channel schedule from the broadcast head-end or the content server. Therefore, it is possible for a subscriber to view various broadcast programs and contents at any desired time. In addition, it is possible for a service provider to reduce the cost for the establishment and maintenance of a server and prevent the quality of broadcast services from deteriorating due to server traffic or load.

### TECHNICAL FIELD

The present invention relates to a subscriber terminal-based personalized broadcast service system and method, and more particularly, to a subscriber terminal-based personalized broadcast service system and method which can provide various desired broadcast programs and contents to a subscriber at any desired time through an internet protocol (IP) network.

The present invention was supported by the IT R&D program of Ministry of Information and Communication (MIC) and Institute for Information Technology Advancement (IITA) [Project No.: 2006-S-058-03, Project Title: Development of AII IPv6-Based Fixed-Mobile Convergence Networking Technology]

### BACKGROUND ART

Conventional internet-based personalized broadcast service systems provide sub-scribers with broadcast program information and allow subscribers to create their own personalized channel schedules. Examples of broadcast services provided by conventional internet-based personalized broadcast service systems include terrestrial broadcast programs, which are generally provided to subscribers by a network personal video recorder (n-PVR) server or an internet protocol (IP) network, cable broadcast programs and satellite broadcast programs. However, conventional internet-based personalized broadcast service systems do not provide personalized broadcast services such as user created contents (UCCs) or video-on-demand (VOD) contents, and thus, subscribers may not be able to watch a UCC or VOD content at a desired time.

Therefore, it is necessary to allow subscribers to create a personalized channel schedule not only including terrestrial broadcast programs, cable broadcast programs and satellite broadcast programs but also UCCs and VOD contents. In addition, it is necessary to provide various broadcast programs, UCCs and VOD contents according to a personalized channel schedule.

In order to realize such a personalized broadcast service, an additional personalized server may be required, thereby incurring additional expense for purchase and maintenance. In addition, since all broadcast programs or contents are provided to subscribers through a single personalized server, the load of the personalized server may considerably increase, and thus, the stability and reliability of the provision of broadcast services may decrease.

### DISCLOSURE OF INVENTION

### Technical Problem

The present invention provides a subscriber terminal-based personalized broadcast service system and method which can improve the variety and quality of broadcasting by allowing a server to directly provide subscribers with various broadcast programs or contents without the need for a service provider to establish an additional server for providing broadcast programs or contents according to a personalized channel schedule.

### Technical Solution

According to an aspect of the present invention, there is provided a subscriber terminal-based personalized broadcast service method including receiving broadcast program schedule information from a broadcast head-end and receiving content schedule information from at least one content server; creating a personalized channel schedule in which a plurality of broadcast programs and a plurality of contents are arranged according to time with reference to the broadcast program schedule information and the content schedule information; and receiving a broadcast program or a content requested with reference to the personalized channel schedule from the broadcast head-end or the content server.

According to an aspect of the present invention, there is provided a subscriber terminal-based personalized broadcast service system including a subscriber schedule providing server providing broadcast program schedule information and content schedule information; a broadcast head-end servicing broadcast programs and providing a broadcast program requested with reference to a personalized channel schedule to a subscriber terminal; and a content server servicing contents and providing a content requested with reference to the personalized channel schedule to the subscriber terminal.

### Advantageous Effects

According to the present invention, it is possible for a subscriber to watch various broadcast programs or contents at any desired time. In addition, it is possible for a service provider to service broadcast programs or contents to a subscriber according to a personalized channel schedule without a requirement of an additional server or equipment and thus to reduce the cost for the establishment and maintenance of a server by allowing a subscriber terminal to directly issue a request for a broadcast program or a content to a broadcast head-end or a content server. Moreover, it is possible to address the problems associated with the establishment of an additional server or equipment such as deterioration of the quality of broadcast services or delays in the transmission/reception of broadcast services.

### BRIEF DESCRIPTION OF DRAWINGS

FIG. 1 illustrates a block diagram of a subscriber terminal-based personalized broadcast service system according to an exemplary embodiment of the present invention;

FIG. 2 illustrates a diagram of electronic program guide (EPG) necessary for creating a personalized channel schedule;

FIG. 3 illustrates a diagram of a service stream transmitted to a subscriber terminal according to a personalized channel schedule created by the subscriber terminal-based personalized broadcast service system shown in FIG. 1;

FIG. 4 illustrates a message sequence chart showing how the subscriber terminal-based personalized broadcast service system shown in FIG. 1 receives a multicast program; and

FIG. 5 illustrates a message sequence chart showing how the subscriber terminal-based personalized broadcast service system shown in FIG. 1 receives a content from a content server.

### BEST MODE FOR CARRYING OUT THE INVENTION

The present invention will hereinafter be described more fully with reference to the accompanying drawings, in which exemplary embodiments of the invention are shown.

According to the present invention, a subscriber terminal may be directly provided with various broadcast programs or contents by a server according to a personalized channel schedule created by a subscriber. Thus, the subscriber can be provided with various high-quality broadcast programs or contents without the need for a service provider to establish an additional server for providing broadcast programs or contents according to the personalized channel schedule.

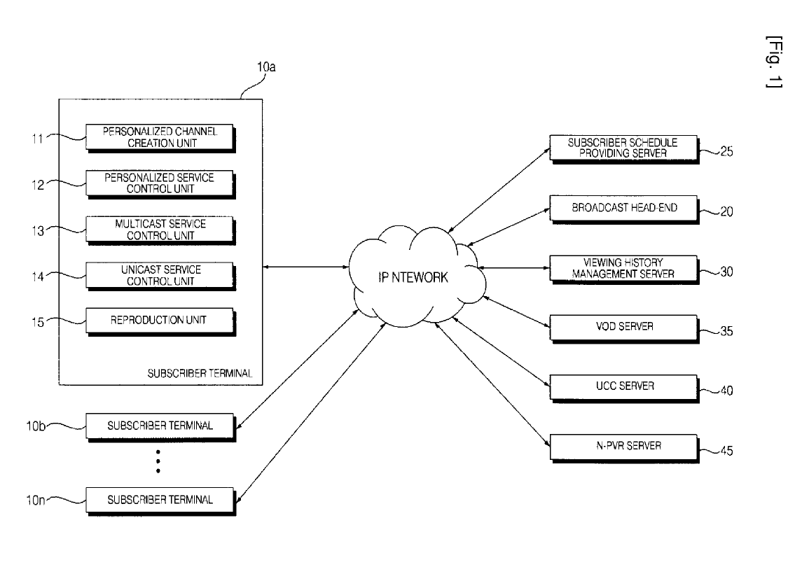

FIG. 1 illustrates a block diagram of a subscriber terminal-based personalized broadcast service system according to an exemplary embodiment of the present invention. Referring to FIG. 1, the subscriber terminal-based personalized broadcast service system may include a broadcast head-end 20, a plurality of content servers 35, 40 and 45, a viewing history management server 30, a subscriber schedule providing server 25, and a plurality of subscriber terminals 10a through 10n.

The broadcast head-end 20 may provide a broadcast service such as a cable broadcast service, a satellite broadcast service or an internet protocol television (IPTV) broadcast service. In addition, the broadcast head-end 20 may receive a terrestrial TV broadcast program or a satellite broadcast program and may provide the received broadcast program to the subscribers of the subscriber terminals 10a through 10n. Moreover, the broadcast head-end 20 may produce a broadcast program and may provide the produced broadcast program or a broadcast program provided by a broadcast program provider to the subscribers of the subscriber terminals 10a through 10n through an IP network.

The content servers 35, 40 and 45 may provide various contents such as video-on-demand (VOD) contents, user-created contents (UCCs) or broadcast programs or contents schedule-recorded by the subscribers of the subscriber terminals 10a through 10n. In addition, the content server 35, 40 and 45 may store various contents created by individuals or VOD service providers and may provide the various contents to the subscribers of the subscriber terminals 10a through 10n.

The content servers 35, 40 and 45 may include a VOD server 35, a UCC server 40 and a network personal video recorder (n-PVR) server 45.

The VOD server 35 may store VOD data and may provide the VOD data to the subscribers of the subscriber terminals 10a through 10n.

The UCC server 40 may store UCCs, which are audio/video contents such as moving image data created by individuals, and may provide the UCCs to the subscribers of the subscriber terminals 10a through 10n.

The n-PVR server 45 may store broadcast programs or contents schedule-recorded by the subscriber terminals 10a through 10n. If each of the subscribers of the subscriber terminals 10a through 10n chooses a plurality of broadcast programs to be broadcast in the same time zone, all the broadcast programs except for one designated as a main broadcast program by a corresponding subscriber may be stored in the n-PVR server 45.

The viewing history management server 30 may store a subscriber viewing history, i.e., a statement regarding the viewing of broadcast programs or contents by each of the subscribers of the subscriber terminals 10a through 10n and may recommend a broadcast program or a content that satisfies a corresponding subscriber's demands and preferences by referencing the subscriber viewing history present in the viewing history management server 30.

The subscriber schedule providing server 25 may receive broadcast program/content schedule information from a terrestrial broadcast provider, a cable broadcast provider, a satellite broadcast provider, an IPTV broadcast provider, the VOD server 35, the UCC server 40 and the n-PVR server 45 and may provide the received broadcast program/content schedule information to the subscriber terminals 10a through 10n. In this manner, the subscriber schedule providing server 25 may allow the subscribers of the subscriber terminals 10a through 10n to configure a personalized channel schedule based on broadcast program/content schedule information. In addition, the subscriber schedule providing server 25 may provide access information necessary for accessing the VOD server 35, the UCC server 40 and the n-PVR server 45 to the subscriber terminals 10a through 10n so that the subscriber terminals 10 through 10n can access the VOD server 35, the UCC server 40 and the n-PVR server 45 and can thus be directly provided with broadcast programs or contents by the VOD server 35, the UCC server 40 and the n-PVR server 45. The access information may include the IP addresses of the VOD server 35, the UCC server 40 and the n-PVR server 45.

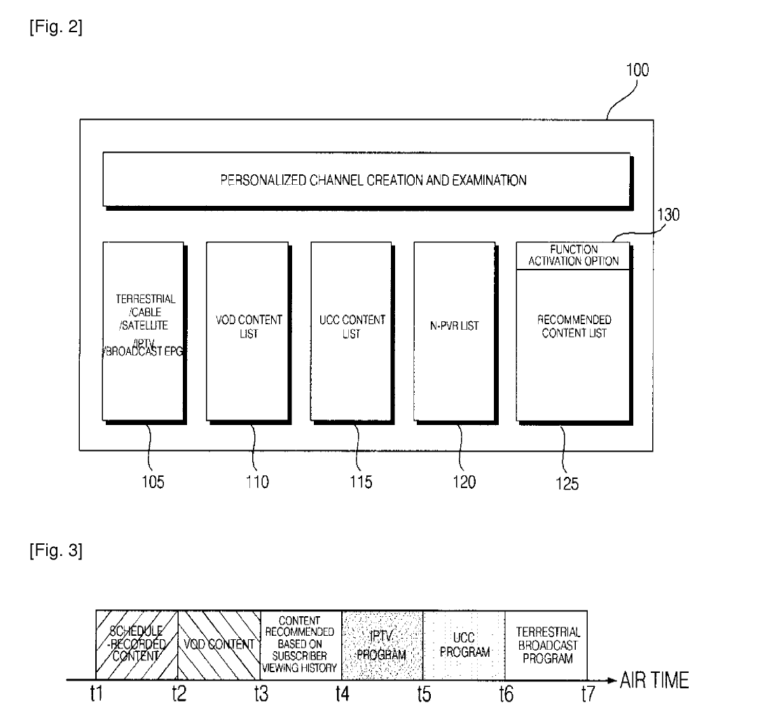

In order for the subscribers of the subscriber terminals 10a through 10n to configure a personalized channel schedule, the subscriber schedule providing server 25 may provide electronic program guide (EPG) 100 shown in FIG. 2 to the subscriber terminals 10a through 10n. Since the EPG 100 includes terrestrial/cable/satellite/IPTV broadcast information 105, an n-PVR list 120, a VOD content list 110, a UCC content list 115, the subscribers of the subscriber terminals 10a through 10n may easily identify various broadcast programs or various contents currently being provided and may thus easily create a personalized channel schedule. In addition, since the EPG 100 also includes a recommended content list 125 including a number of broadcast programs or contents recommended by the viewing history management server 30 based on the subscriber viewing history present in the viewing history management server 30, the subscribers of the subscriber terminals 10a through 10n may easily choose any desired broadcast program or content from the recommended content list 125 and may add the chosen broadcast program or content to a personalized channel schedule. The EPG 100 may also include a function activation option 130 for determining whether to activate or inactivate a function of displaying the recommended content list 125.

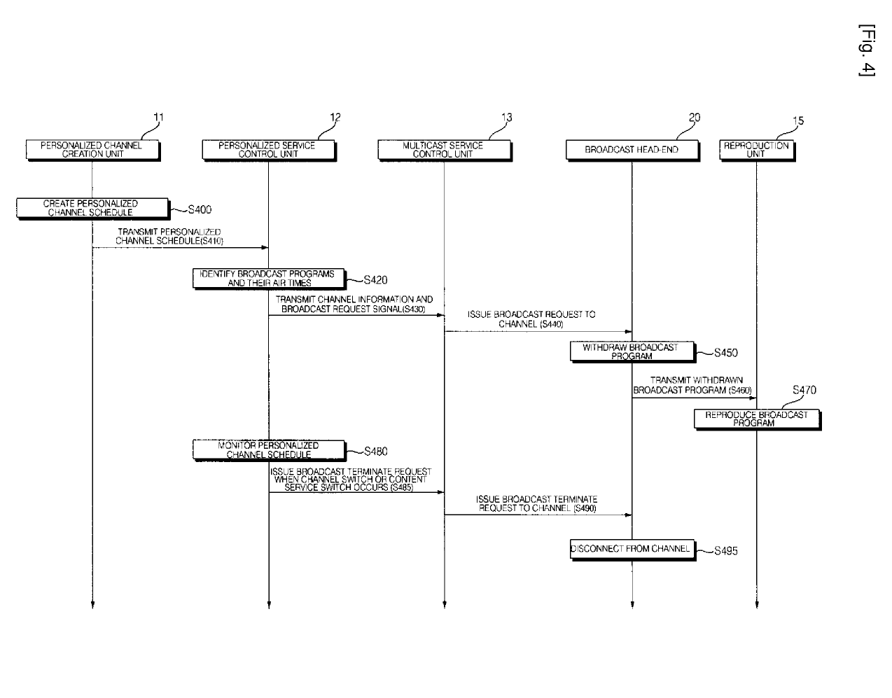

Once a personalized channel schedule is created based on the EPG 100 provided by the subscriber schedule providing server 25, as shown in FIG. 3, the subscribers of the subscriber terminals 10a through 10n may be provided with various broadcast programs or contents through streaming according to the personalized channel schedule.

The subscriber schedule providing server 25 may provide the subscriber terminals 10a through 10n with broadcast program schedule information provided by the broadcast head-end 20 and content schedule information provided by the VOD server 35, the UCC server 40 and the n-PVR server 45 whenever the subscriber terminals 10a through 10n access the personalized schedule providing server 25. In addition, the subscriber schedule providing server 25 may provide the subscriber terminals 10a through 10n with updates, if any, in the broadcast program schedule information or the content schedule information.

Each of the subscriber terminals 10a through 10n may issue a request for contents to a server for providing broadcast services and contents according to a personalized channel schedule created by a corresponding subscriber terminal. Each of the subscriber terminals 10a through 10n may include a personalized channel creation unit 11, a personalized service control unit 12, a multicast service control unit 13, a unicast service control unit 14 and a reproduction unit 15. The subscriber terminals 10a through 10n may be implemented as personal computers (PCs), IP set-top boxes (STBs), home gateways or TVs capable of displaying broadcast programs provided thereto through the internet.

The personalized channel creation unit 11 may store and manage a personalized channel schedule created by the corresponding subscriber terminal. The personalized channel schedule may include broadcast program/content information regarding a plurality of broadcast programs and/or contents chosen by a subscriber of the corresponding subscriber terminal and content server access information indicating how to access the VOD server 35, the UCC server 40 and the n-PVR server 45 to acquire the chosen contents.

The broadcast program/content information may include title information, director information, genre information, main character information, air time information, subscriber preference information and content quality information. The content server access information may include the IP addresses and media access control (MAC) addresses of the VOD server 35, the UCC server 40 and the n-PVR server 45 and communication protocol information of the VOD server 35, the UCC server 40 and the n-PVR server 45.

The personalized service control unit 12 may monitor the personalized channel schedule managed by the personalized channel creation unit 11 and may operate the multicast service control unit 13 or the unicast service control unit 14 according to whether a broadcast program or a content is to be output to the corresponding subscriber terminal.

In order to be provided with a multicast program, the multicast service control unit 13 may transmit a membership report message (IGMPjoin) to a network. More specifically, if a broadcast program desired by the subscriber of the corresponding subscriber terminal is not being multicast through a network, the membership report message may be transmitted to the broadcast head-end 20 through a multicast communication protocol that operates in the network. If the membership report message is received, the broadcast head-end 20 may withdraw the desired broadcast program and may transmit the withdrawn broadcast program to the corresponding subscriber terminal. On the other hand, if the desired broadcast program is currently being multicast through a network, the multicast service control unit 13 may receive a broadcast stream corresponding to the desired broadcast program and may transmit the received broadcast stream to the reproduction unit 15, instead of issuing a request for the desired broadcast program to the broadcast head-end 20.

The personalized service control unit 12 may monitor the personalized channel schedule managed by the personalized channel creation unit 11. If the personalized channel schedule includes VOD contents or UCC contents provided by the VOD server 35, the UCC server 40 and the n-PVR server 45, the personalized service control unit 12 may choose the VOD server 35, the UCC server 40 and the n-PVR server 45 and may determine how to access the VOD server 35, the UCC server 40 and the n-PVR server 45. More specifically, the personalized service control unit 12 may choose one or more content servers that can provide the contents included in the personalized channel schedule, i.e., the VOD server 35, the UCC server 40 and the n-PVR server 45, and may transmit content server access information necessary for accessing the VOD server 35, the UCC server 40 and the n-PVR server 45 such as the IP addresses and MAC addresses of the VOD server 35, the UCC server 40 and the n-PVR server 45 and communication protocol information of the VOD server 35, the UCC server 40 and the n-PVR server 45 to the unicast service control unit 14.

The unicast service control unit 14 may transmit a signal requesting the contents included in the personalized channel schedule to the VOD server 35, the UCC server 40 and the n-PVR server 45 with reference to the content server access information provided by the personalized service control unit 12. If the contents included in the personalized channel schedule are received from the VOD server 35, the UCC server 40 and the n-PVR server 45, the reproduction unit 15 may reproduce the received contents.

The reproduction unit 15 may reproduce terrestrial/cable/satellite/IPTV broadcast streams transmitted thereto through a network or UCCs or VOD contents provided by the VOD server 35, the UCC server 40 and the n-PVR server 45.

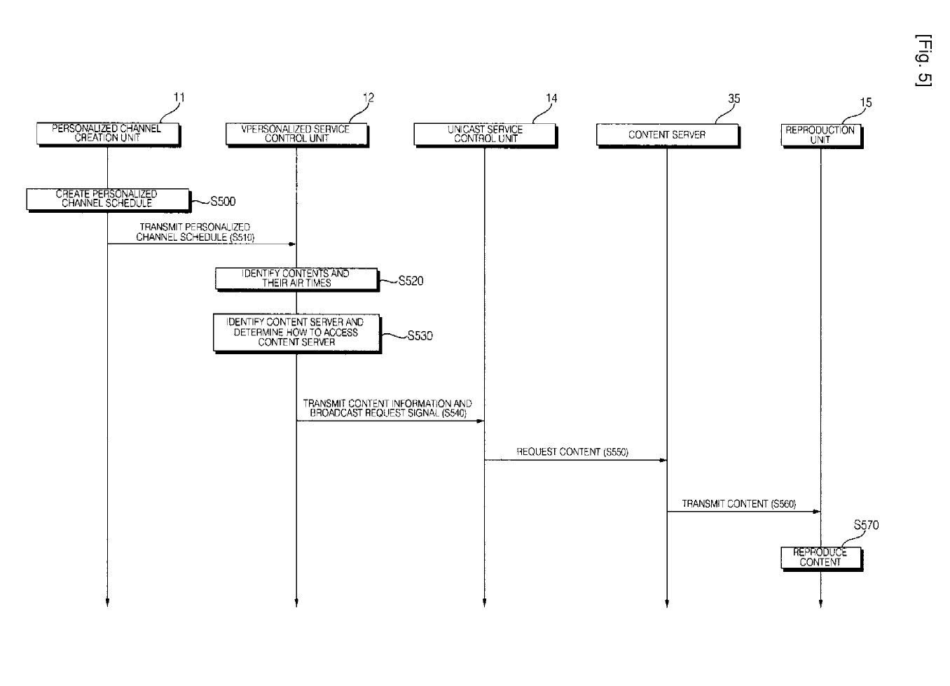

FIG. 4 illustrates a message sequence chart showing how the subscriber terminal-based personalized broadcast service system shown in FIG. 1 receives a multicast program. Referring to FIG. 4, if a subscriber creates a personalized channel schedule using a personalized channel creation unit 11 of his or her subscriber terminal (S400), a personalized service control unit 12 of the subscriber terminal may monitor the personalized channel schedule. The personalized service control unit 12 may identify a plurality of broadcast programs listed in the personalized channel schedule and the air times of the broadcast programs. If one of the broadcast programs is a multicast program, channel information of a broadcast channel providing the multicast program and a signal requesting the broadcast of the multicast program may be transmitted to a multicast service control unit 13 of the subscriber terminal (S420 and S430).

Thereafter, the multicast service control unit 13 may transmit a membership report message to the broadcast head-end 20 and may thus issue a request for the transmission of the multicast program to the broadcast head-end 20 (S440). The broadcast head-end 20 may withdraw the multicast program from the broadcast channel providing the multicast program (S450), and may transmit a broadcast stream corresponding to the multicast program to the subscriber terminal (S460). Then, the broadcast stream may be transmitted to and reproduced by a reproduction unit 15 of the subscriber terminal. Once the reproduction of the broadcast stream is complete, the personalized service control unit 12 may determine whether a broadcast program or a content is to be provided next to the multicast program and whether the next broadcast program is provided by the same broadcast channel as the multicast program (S480). If it is determined that a broadcast program is to be provided next to the multicast program and that the next broadcast program is provided by a different channel from the multicast program or if it is determined that what is provided next to the multicast program is a content, the multicast service control unit 13 may transmit a membership-leave message to the broadcast head-end 20 (S485) so that no broadcast program can be received any longer from the broadcast channel providing the multicast program (S490). Thereafter, the broadcast head-end 20 may be disconnected from the broadcast channel providing the multicast program and may terminate the transmission of a broadcast stream (S495). The exemplary embodiment of FIG. 4 can be applied to the request for and the reception and reproduction of another broadcast program.

FIG. 5 illustrates a message sequence chart showing how the subscriber terminal-based personalized broadcast service system shown in FIG. 1 receives a content from one of the content servers 35, 40 and 45. Referring to FIG. 5, if a subscriber creates a personalized channel schedule using a personalized channel creation unit 11 of his or her subscriber terminal (S500), the personalized channel creation unit 11 may transmit the personalized channel schedule to a personalized service control unit 12 of the subscriber terminal (S510). The personalized channel schedule may not necessarily have to be transmitted from the personalized channel creation unit 11 to the personalized service control unit 12. That is, if the personalized channel schedule is managed by the personalized channel creation unit 11, the personalized service control unit 12 may access the personalized channel creation unit 11.

The personalized service control unit 12 may identify a number of contents listed in the personalized channel schedule and the air times of the contents (S520). If the contents listed in the personalized channel schedule are provided by the VOD server 35, the UCC server 40 and the n-PVR server 45, the personalized service control unit 12 may choose the VOD server 35, the UCC server 40 and the n-PVR server 45 with reference to the personalized channel schedule and may determine how to access the VOD server 35, the UCC server 40 and the n-PVR server 45 (S530). Thereafter, the personalized service control unit 12 may transmit the results of the determination performed in operation S530 to a unicast service control unit 14 of the subscriber terminal and may order the service control unit 14 to issue a request for the contents listed in the personalized channel schedule to the VOD server 35, the UCC server 40 and the n-PVR server 45 (S540).

Thereafter, the unicast service control unit 14 may issue a request for the contents listed in the personalized channel schedule to the VOD server 35, the UCC server 40 and the n-PVR server 45 (S550). If the contents listed in the personalized channel schedule are received from the VOD server 35, the UCC server 40 and the n-PVR server 45 (S560), a reproduction unit 15 of the subscriber terminal may reproduce the received contents (S570).

The subscriber terminal-based personalized broadcast service system may allow a personalized service control unit 12 of a subscriber terminal to issue a request for broadcast programs and/or contents to the broadcast head-end 20, the VOD server 35, the UCC server 40 and the n-PVR server 45 according to a personalized channel schedule created by a subscriber. Therefore, it is possible for the subscriber to view various broadcast programs and/or contents at any desired time according to the personalized channel schedule.

While the present invention has been particularly shown and described with reference to exemplary embodiments thereof, it will be understood by those of ordinary skill in the art that various changes in form and details may be made therein without departing from the spirit and scope of the present invention as defined by the following claims.

### INDUSTRIAL APPLICABILITY

According to the present invention, it is possible to provide a subscriber with various broadcast programs or contents at any desired time through an interne protocol (IP) network. Therefore, it is possible for a subscriber to view various broadcast programs and contents at any desired time. In addition, it is possible for a service provider to reduce the cost for the establishment and maintenance of a server and prevent the quality of broadcast services from deteriorating due to server traffic or load.

1. A subscriber terminal-based personalized broadcast service method comprising:
receiving broadcast program schedule information from a broadcast head-end and receiving content schedule information from at least one content server;
creating a personalized channel schedule in which a plurality of broadcast programs and a plurality of contents are arranged according to time with reference to the broadcast program schedule information and the content schedule information; and
receiving a broadcast program or a content requested with reference to the personalized channel schedule from the broadcast head-end or the content server.

2. The subscriber terminal-based personalized broadcast service method of claim 1, further comprising, if a channel of a broadcast stream provided by the broadcast head-end is different from a channel of a broadcast program next to the broadcast stream, disconnecting from the channel of the broadcast stream after the transmission of the broadcast stream.

3. The subscriber terminal-based personalized broadcast service method of claim 1, wherein the content server is one of a video-on-demand (VOD) server which stores and services VOD contents, a user-created content (UCC) server which stores and services UCCs, and a network personal video recorder (n-PVR) server which stores and services broadcast programs or contents recorded by a subscriber.

4. The subscriber terminal-based personalized broadcast service method of claim 1, wherein the receiving of the requested content comprises receiving content server access information indicating how to access the content server and accessing the content server with reference to the content server access information.

5. The subscriber terminal-based personalized broadcast service method of claim 1, wherein the receiving of the broadcast program schedule information and the content schedule information comprises receiving electronic program guide (EPG) including terrestrial/cable/satellite/internet protocol television (IPTV) broadcast program schedule information, an n-PVR list, a VOD content list, and a UCC list.

6. The subscriber terminal-based personalized broadcast service method of claim 1, further comprising choosing and recommending a broadcast program or content that suits a subscriber's requirements or preferences based on the subscriber's viewing history.

7. A subscriber terminal-based personalized broadcast service system comprising:
a subscriber schedule providing server providing broadcast program schedule information and content schedule information;
a broadcast head-end servicing broadcast programs and providing a broadcast program requested with reference to a personalized channel schedule to a subscriber terminal; and
a content server servicing contents and providing a content requested with reference to the personalized channel schedule to the subscriber terminal.

8. The subscriber terminal-based personalized broadcast service system of claim 7, wherein the subscriber terminal comprises a personalized channel creation unit storing and managing the personalized channel schedule, a personalized service control unit issuing a request for a broadcast program or a content to the broadcast head-end or the content server with reference to the personalized channel schedule, and a reproduction unit reproducing a broadcast program provided by the broadcast head-end or a content provided by the content server.

9. The subscriber terminal-based personalized broadcast service system of claim 7, wherein the subscriber terminal comprises a multicast service control unit issuing a request for the transmission of a broadcast stream included in the personalized channel schedule to the broadcast head-end and issuing a request for the termination of the transmission of the broadcast stream to the broadcast head-end in order to receive another broadcast stream from a channel different from that of the current broadcast stream.

10. The subscriber terminal-based personalized broadcast service system of claim 7, wherein the personalized service control unit identifies the content server, determines how to access the content server, and the subscriber terminal comprises a unicast service control unit issuing, using a content server access method determined by the personalized service control unit, a request for the transmission of a content to one of a VOD server storing and servicing VOD contents, a UCC server storing and servicing UCCs, and an n-PVR server storing and servicing broadcast programs or contents recorded by a subscriber.
